(19) United States
(12) Patent Application Publication
(10) Pub. No.: US 2005/0273858 A1
(43) Pub. Date: Dec. 8, 2005

(54) Stackable file systems and methods thereof

(76) Inventors: Erez Zadok, Stony Brook, NY (US); Charles P. Wright, Port Jefferson Station, NY (US); Akshat Aranya, New Delhi (IN); Abhijith Damodara Das, Westbury, NY (US); Yevgeniy Y. Miretskiy, Coram, NY (US); Kiran-Kumar Muniswamy-Reddy, Bangalore (IN); Andrew Paul Himmer, Arlington, MA (US)

Correspondence Address: F. CHAU & ASSOCIATES, LLC, 130 WOODBURY ROAD, WOODBURY, NY, 11797, US

(21) Appl. No.: 10/862,212

(22) Filed: Jun. 7, 2004

(51) Int. Cl. G06F 15/16

(52) U.S. Cl. 726/24; 709/230

(57) ABSTRACT

An operating system kernel, including a protocol stack, includes a network layer for receiving a message from a data network, a stackable file system layer coupled to the network layer for inspecting the message, wherein the stackable file system layer is coupled to a storage device, the stackable file system determining and storing file system level information determined from the message, and a wrapped file system comprising a file targeted by the message coupled to the stackable file system layer for receiving the message inspected by the stackable file system.

### BACKGROUND OF THE INVENTION

1. Field of the Invention

The present invention relates to network file systems, and more particularly to stackable file systems.

2. Discussion of Related Art

Communications between computers depend upon a basic architecture. For example, the International Standards Organization (ISO) protocol stack is a set of cooperating sequential protocols that pass messages between one another. FIG. 1 shows the ISO protocol stack 100 connected to a data communications network 101. The stack 100 comprises a physical layer 102, a data-link layer 103, and a network layer 104. The stack further comprises a transport layer 106, a session layer 107, a presentation layer 108, and an application layer 109.

The physical layer 102 handles the physical transmission of a bit stream over the data communications network 101. The physical layer 102 is typically embodied as a networking device. The data-link layer 103 handles frames, or packets of data. The data-link layer 103 typically performs error detection and recovery of bit stream content from the physical layer 102. The network layer 104 routes the packets of data, handling addressing, encoding and decoding of packets. The transport layer 105 controls the handling and flow of messages between computers. The session layer 106 implements sessions or process-to-process communications, for example, mail, remote logins, and file transfer. The presentation layer 107 handles file formats, resolving differences between clients in the network. The application layer 108 is the interface with an end user. The application layer 108 manages file transfer, access, and management.

Each layer modifies a message received via the data communications network 101. A message moves up the stack after being received from the data communications network 101. At each subsequent layer, additional information is extracted from the message, and it can be said that the message becomes less abstract.

More modern stacks include the TCP/IP protocol stack. The TCP/IP stack has fewer layers than the ISO protocol stack, however; many of the functions of individual layers of the ISO protocol stack can be identified in the more compact and efficient TCP/IP protocol.

Applications for detecting viruses and tracing computer use typically operate on information gleamed at a low level in the stack, e.g., the network level. Accordingly, the information can be abstract and difficult to interpret.

Therefore, a need exists for a stackable file system for performing, inter alia, location-independent network intrusion detection, file system traces, versioning, and virus protection, at a file system level in the stack.

### SUMMARY OF THE INVENTION

An operating system kernel, including a protocol stack, includes a network layer for receiving a message from a data network, a stackable file system layer coupled to the network layer for inspecting the message, wherein the stackable file system layer is coupled to a storage device, the stackable file system determining and storing file system level information determined from the message, and a wrapped file system comprising a file targeted by the message coupled to the stackable file system layer for receiving the message inspected by the stackable file system.

The stackable file system layer includes a filter, wherein the message is compared to the filter, the filter being one of a virus signature, and an expression specifying an object and an operation.

The stackable file system layer comprises a filter, wherein the message is compared to the filter, the filter specifying file system operations triggering a version save to the storage device.

The protocol stack includes a virus-scanning engine coupled between the stackable file system and the storage device, wherein the storage device includes a virus database of virus signatures accessed by the virus-scanning engine. The virus-scanning engine scans the message before data from a read( ) is delivered to a user and before data from a write( ) propagates to a data storage device.

The stackable file system layer stores a version of the file targeted by the message upon determining a change in the file.

The filter performs an operation trace, wherein the filter includes an input filter for determining the operations to trace, an assembly driver for converting the traced operations and corresponding parameters into a stream, an output filter for performing a stream transformation, and an output driver for writing the stream out from the kernel to the storage device.

A stackable file system method includes mounting a stackable file system on top of a target file system, wherein a stackable file system is loaded in a kernel below a system call level and above a network layer, exporting a mount point of the stackable file system to a client, monitoring a message targeting a file in the target file system, through the stackable file system, and storing information about the message upon determining that the message satisfies a filter.

The stackable file system is mounted on one file system or a server comprising the target file system.

The method includes exporting the target file system to a proxy, wherein the proxy exports the mount point of the stackable file system to the client.

The stackable file system monitors messages for predetermined behavior.

### BRIEF DESCRIPTION OF THE DRAWINGS

Preferred embodiments of the present disclosure will be described below in more detail, with reference to the accompanying drawings:

FIG. 1 is a diagram of an ISO protocol stack;

FIG. 2 is a diagram of a TCP/IP protocol stack according to an embodiment of the present disclosure;

FIG. 3 is a diagram of a system according to an embodiment of the present disclosure;

FIG. 4 is a diagram of a trace file system according to an embodiment of the present disclosure;

FIG. 5 is a diagram of a tracer according to an embodiment of the present disclosure;

FIG. 6 is a diagram of an anti-virus file system according to an embodiment of the present disclosure;

FIG. 7 is an illustration of an anti-virus automaton according to an embodiment of the present disclosure;

FIG. 8 is a diagram of a versioning file system according to an embodiment of the present disclosure;

FIGS. 9A and 9B show file system trees for a versioning stackable file system according to an embodiment of the present disclosure;

FIG. 10A illustrates a full storage policy of a versioning stackable file system according to an embodiment of the present disclosure;

FIG. 10B illustrates a current file for a sparse storage policy of a versioning stackable file system according to an embodiment of the present disclosure;

FIG. 10C illustrates a sparse storage policy of a versioning stackable file system according to an embodiment of the present disclosure;

FIG. 11 is a flow chart of a method for mounting file systems to a stackable file system according to an embodiment of the present disclosure;

FIG. 12 is a flow diagram of an on-exit callback method according to an embodiment of the present disclosure; and

FIG. 13 is a flow diagram of a cache validation method according to an embodiment of the present disclosure.

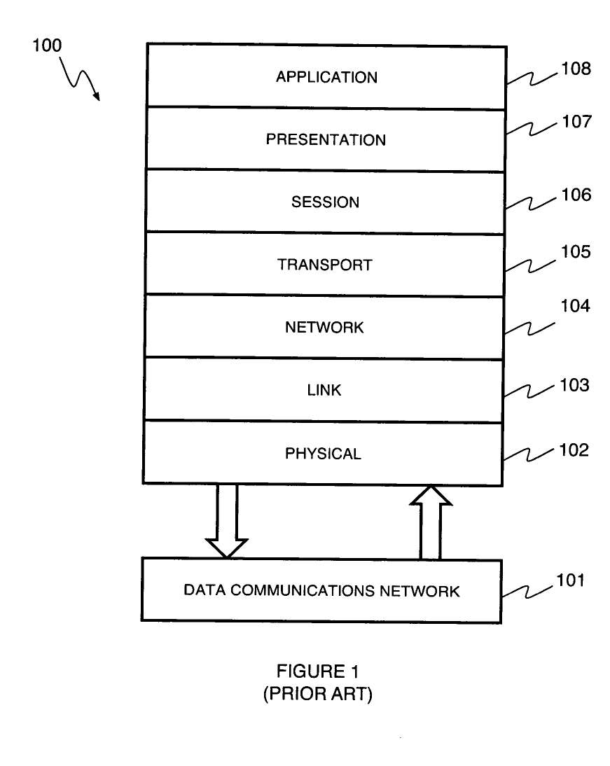

### DETAILED DESCRIPTION OF PREFERRED EMBODIMENTS

A stackable file system (stacking) is a layered software technology that can be used to wrap another file system, even another stackable file system. By wrapping other file systems, stackable file systems can monitor file system activity that comes from users before that activity is passed on to the actual file system that the stackable file system is wrapping. Accordingly, the network file system is a proxy implementing stacking.

For example, the stackable file system can be invoked with a request to create a new file, and it can decide, based on a set of rules, to allow or deny the access needed to create the new file; if it allows the access, the stackable file system can pass-through the file creation request to the underlying, wrapped, file system.

In another example, the stackable file system can transparently encrypt and decrypt data, e.g., from a file, passing through the stack. For example, a user issues a request via a system call to write to a data file; the stackable file system encrypts a data buffer and reissues the write request to the wrapped file system, wherein the stackable file system passes the encrypted data buffer to the wrapped file system. This provides transparent encryption without user intervention.

Further, stackable file systems appear to a running system as a regular file system no different than other file systems (e.g., Network File System (NFS), Flash File System (FFS), Second Extended File System (EXT2), UNIX File System (UFS), Common Internet File System (CIFS), etc.). Thus, a stackable file system can be exported via system methods, through the network, to remote clients using for example, NFS or CIFS.

When combining the layering and exporting abilities of stackable file systems, a network file system proxy device can be produced using stackable file systems. For example, in a system comprising a networked file system (e.g., NFS, CIFS, etc.), a client C, and a matching server S, client C can access the file system on S via the network. A proxy device P is disposed in between C and S. S exports its file system to P. P mounts the file system from S. P mounts a second, stackable file system on top of the mounted file system of S. P exports the stackable file system mount point to client C. C mounts the exported file system from P.

This scenario can be done without the knowledge, intervention, or reconfiguration of either S or C. P acts as a transparent proxy, monitoring all file system activities.

Mounting a file system includes, for example, passing to the kernel the name of the file system, the physical block device including the file system and, where in the existing file system topology the new file system is to be mounted.

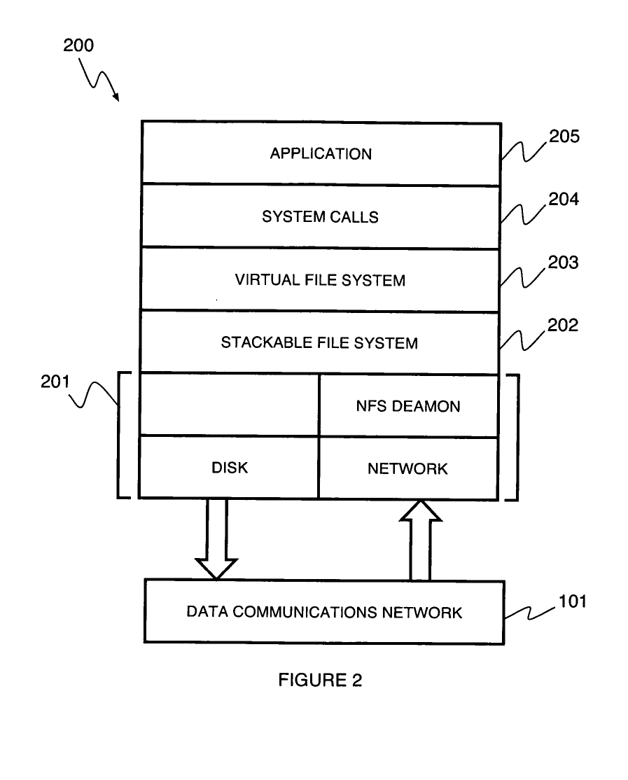

Referring to FIG. 2, whereas prior proxy techniques use network-layer packet analysis and retransmission, stackable file systems achieve the proxying techniques at a higher conceptual level—the stackable file system level 202. At the network level 201, important information can be lost to the proxying software, information such as the identity of users, groups, and processes, as well as file names. At the stackable file system level 202, on the other hand, this information is available. Therefore, a transparent file system proxy can perform more intelligent decisions than a file system at the network level 201.

Note that this proxying technique can also be achieved by directly mounting the stackable file system on the server's (S) own exported file systems. That is, a separate intermediate device (P) is not needed for file system proxying using stackable file systems. The same benefits can be achieved entirely in software deployed either on servers or clients.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

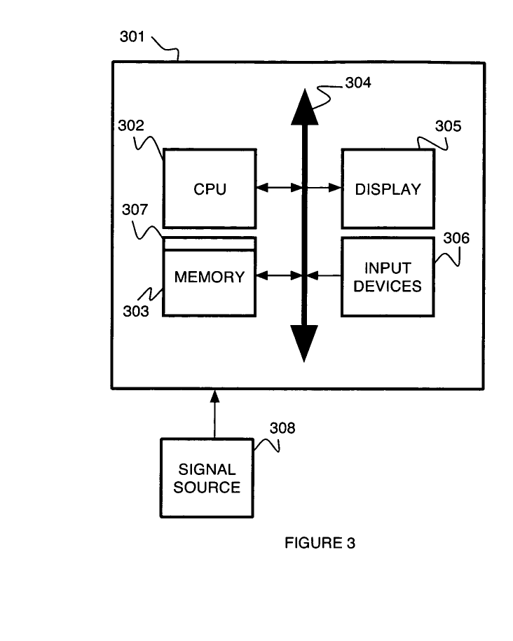

Referring to FIG. 3, according to an embodiment of the present disclosure, a computer system 301 for implementing the present disclosure can comprise, inter alia, a central processing unit (CPU) 302, a memory 303 and an input/output (I/O) interface 304. The computer system 301 is generally coupled through the I/O interface 304 to a display 305 and various input devices 306 such as a mouse and keyboard. The support circuits can include circuits such as cache, power supplies, clock circuits, and a communications bus. The memory 303 can include random access memory (RAM), read only memory (ROM), disk drive, tape drive, etc., or a combination thereof. The present disclosure can be implemented as a routine 307 that is stored in memory 303 and executed by the CPU 302 to process the signal from the signal source 308. As such, the computer system 301 is a general-purpose computer system that becomes a specific purpose computer system when executing the routine 307 of the present disclosure.

The computer platform 301 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

It should be noted that different file systems can be written as wrapper file systems having different functionality. For example, file systems can be implemented for intrusion detection, intrusion avoidance, analysis, access control, and encryption. Useful file systems can be written with a small amount of code and rapidly prototyped. Moreover, several such file systems can be stacked together, to form a union of their functionality.

The stackable encryption file system may be deployed in a variety of applications. Among the applications are file system traces and anti-virus file systems. Various embodiments of the present disclosure are described below as examples of stackable file system implementations.

Intrusion Detection System

According to an embodiment of the present disclosure, a file system intrusion detection system (IDS) works at the stackable file system level 202, below systems calls 204, but above the network layers 201. When such an IDS uses file system stacking on a file server having a Virtual File System (VFS) 203, it can monitor all file access activities as if they were executed on the client. The VFS 203 manages the different file systems that are mounted at any given time. The VFS 203 maintains data structures that describe the whole (e.g., virtual) file system and the real, mounted, file systems.

Intrusion detection techniques such as misuse detection and anomaly detection approaches may be implemented with the file system IDS. Misuse detection techniques detect attacks as instances of attack signatures. The attack signatures may be stored in a library accessed by the file system IDS. Anomaly detection uses a definition of normal system behaviors. In anomaly detection, machine-learning techniques may be used to learn normal behavior by observing the file system operation during a training phase that is free of attacks. Subsequently, this learnt behavior is compared against observed system behavior during the detection phase, and any deviations are deemed to indicate attacks.

As such, a file system IDS monitors messages for predetermined behavior indicative of a security event. For example, repeated attempts to delete a large number of files, attempts to access unauthorized files (“snooping”), and attempts to copy large amounts of proprietary data, even by authorized users who deviate from a predetermined usage pattern.

The file system IDS has full access to file data and operations. Therefore, file system operations of the wrapped file system can be accurately observed and filtered. Further, the file system IDS can check the validity of the data before permitting it to be written to a server or read by a user. Checking validity includes checking integrity using checksum methods (e.g., SHA1 and MD5), as well as Virus Protection (e.g., inspecting file data for known and unknown patterns indicating that the file contains a virus, other malicious code, or any other undesirable patterns).

File System Trace

A thin stackable file system for capturing file system traces may be deployed for analyzing user behavior and system software behavior. A file system trace system (FSTS) can capture uniform traces for a variety of file systems without modifying the file system being traced. The FSTS can capture traces at various degrees of granularity: by users, groups, processes, files and file names, file operations, and more; it can transform trace data into aggregate counters, compressed, checksummed, encrypted, or anonymized streams; and it can buffer and direct the resulting data to various destinations (e.g., sockets, disks, etc.). The FSTS is modular and extensible, allowing for uses beyond traditional file system traces. For example, a FSTS can wrap around other file systems for debugging or intrusion detection. Intrusion detection may be built into the input filter and tracers, wherein predetermined intrusion signatures are searched. The storage module 405 may be used to store information about intrusion event, e.g., operations determined to satisfy the filters.

Among the potential modules are input filters, output filters, and output drivers. The input filters can efficiently determine what to trace by users, groups, processes, sessions, file system operations, file names and attributes, and more. Output filters may control trace data manipulations such as encryption, compression, buffering, checksumming, as well as aggregation operators that count frequencies of traced operations. Output drivers can determine the amount of buffering to use and where the trace data stream should be directed: a raw device, a file, or a local or remote socket. The traces are portable and self-describing to preserve their usefulness in the future. A set of user-level tools can anonymize selective parts of a trace with encryption keys that can unlock desired subsets of anonymized data. The design of the FSTS decomposes the various components of the system in an extensible manner, to allow others to write additional input or output filters and drivers.

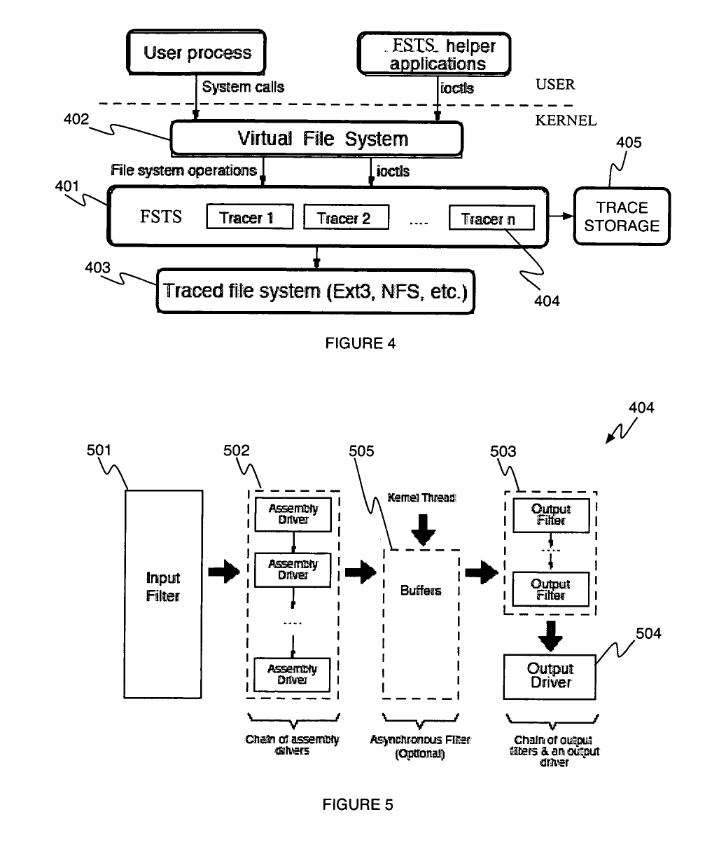

A FSTS may be implemented as a stackable file system that can be stacked on top of any underlying file system. FIG. 4 shows that a FSTS 401 is a thin layer between the VFS 402 and another file system 403. File system-related system calls invoke VFS calls, which in turn invoke an underlying file system 403. When the FSTS 401 is stacked on top of another file system 403, the VFS calls are intercepted by the FSTS 401 before being passed to the underlying file system 403. Before invoking the underlying file system 403, the FSTS calls hooks into one or more tracers that trace the operation. Another hook is called at the end of the operation to trace a return value.

FIG. 5 depicts an architecture of the FSTS tracing infrastructure. It includes four components: input filters 501, assembly drivers 502, output filters 503, and output drivers 504. Input filters 501 are invoked using hooks from the file system layer. Input filters 501 determine which operations to trace. Assembly drivers 502 convert a traced operation and its parameters into a stream format. Output filters 503 perform a series of stream transformations including, checksum (e.g., adding a piece of information to the stream indicating the streams size), encryption, compression, etc. Output drivers 504 write the trace stream out from the kernel to an external entity, like a file or a socket. Output drivers 504 are similar to output filters 503 in that they operate on a stream of bytes. An output driver 504 writes out the trace stream after it has gone through a series of transformations using output filters. Like output filters 503, output drivers 504 also employ buffering for efficiency.

An optional buffer 505 can be implemented for asynchronous processing of the stream.

A combination of an input filter 501, an assembly driver 502, an output filter 503, and an output driver 504 defines a tracer. The FSTS may support multiple tracers, which makes it possible to trace the same system simultaneously under different trace configurations. The input filter 501 allows a user or system administrator to build a directed acyclic graph having arbitrarily complex expressions. For example, the expressions may filter for user identification, group identification, system identification, etc. The filters may also be applied to variables such as file name, inode number, or a set of operations. An example of a filter may be written as:
((UID=0) && (Name=foo)) ||((GID=4) && (Op=open))
wherein, the filter checks for a user identification (UID) of “0” and a file name (Name) “foo” or a group identification (GID) of “4” and an operation (Op) of “open”. File system objects and operations fitting this filter are formed into a stream by the assembly drivers 502 and delivered to either the buffer 505 or output filters 503.

Each component has a well-defined API. The APIs can be used to extend the functionality of the FSTS. Custom drivers may be written with little knowledge of kernel programming or file system internals. An output driver or output filter defines operations including: initialize, release, write, flush, and get the preferred block size. An assembly driver needs the implementation of pre-call and post-call stubs for every VFS operation of interest. Including initialization and cleanup, an assembly driver may have up to 74 operations on Linux. Pre-call methods invoke the assembly driver before the actual operation is passed to the lower-level file system; post-call methods invoke the assembly driver after the call to the lower-level file system. For example, an assembly driver that is interested in counting the frequency of file creation and deletion need only implement two methods: CREATE and UNLINK. Custom drivers can be plugged into the existing infrastructure easily.

Traces are generated in a binary format to save space and facilitate parsing. The trace file is composed of two basic building blocks: an argument and a message.

An argument represents a field of data in the trace, for example, a PID, UID, timestamp, etc. Each argument is an (arg_id, value) or an (arg_id, length, value) tuple. The arg_id parameter specifies a unique identifier for the argument. The length parameter is only needed for variable-length fields like file names and process names. The length of constant-length fields can be omitted, thus saving space in the trace. The highest bit of arg_id is zero for constant-length fields to indicate that there is no length field. Anonymization toggles the highest bit of arg_id for constant-length arguments since the length of arguments changes after encryption, due to padding.

A message is the smallest unit of data written to the trace. It represents all the data traced for one file system operation. Each message consists of a message identifier, msg_id, a length field, and a variable number of arguments. The length field is the length of the entire message. When parsing the trace file, the parser can quickly skip over messages by just reading the msg_id and length fields without parsing the arguments. The trace file is self-contained in the sense that the meta-data information is encoded within the trace. A trace parser needs to be aware only of the basic building blocks of the trace. The header encodes the message identifiers and argument identifiers with their respective string values. The length of constant-length arguments is also encoded in the header so that it need not be repeated each time the argument occurs in the trace. The length may vary on different platforms and it can be determined from the header when the trace is parsed. The header also encodes information about the machine the trace was recorded on, the operating system version, hardware characteristics like the disk capacity of the mounted file system and the amount of random access memory (RAM), the input filter, the assembly drivers, the output filters, the output driver for the trace, and other system state information.

Distribution of traces may raise concerns about security and privacy. It may not be desirable to distribute traces in their entirety as they may reveal too much information about the traced system, especially about user and personal activity. Traces may therefore be anonymized before they are released publicly.

A secret-key encryption method using Cipher Block Chaining (CBC) is implemented to hide certain information in the trace. Each argument type in the trace is encrypted with a different randomly generated key. Encryption provides a one-to-one reversible mapping between unanonymized and anonymized fields. Also, different mappings for each field remove the possibility of correlation between related fields, for example UID=0 and GID=0 may occur together in traces, but this cannot be easily inferred from the anonymized traces in which the two fields have been encrypted using different keys. Trace files generated by FSTS 401 are anonymized offline during post-processing. This allows anonymization of one source trace file in multiple ways.

A user-level anonymization tool allows selection of the arguments to be anonymized. For example, in one set of traces it may be desirable to anonymize only the file names, whereas in another, UIDs and GIDs may also be anonymized. Anonymized traces may be distributed publicly without encryption keys. Specific encryption keys can be privately provided to someone who needs to extract unanonymized data. Also, the use of encryption makes anonymization more efficient since lookup tables are not needed to map each occurrence of a data field to the same anonymized value. The anonymization approach is stateless: no additional information is needed other than one encryption key for each type of data anonymized.

Anti-Virus Stackable File System

Another example of an application of a stackable file system is an anti-virus stackable file system (AVFS). The AVFS can add virus detection to other file systems including Ext3, NFS, etc. AVFS supports forensic modes that can prevent a virus from reaching the disk, automatic versioning of potentially infected files to allow safe recovery, quarantining of known infected files, and isolation of infected files from user processes.

The AVFS system is a kernel-based virus scanner module and a file system. The virus scanner module is called by the file system to perform scanning every time files are read for the first time, created, or modified. This is an on-access scanning method. An on-access scanner looks for viruses when an application reads or writes data, and can prevent a virus from ever being written to disk. Since scanning is performed when data is read, as opposed to when the file is opened, users are not faced with unexpected delays. Since scanning is performed when data is written, as opposed to when the file is closed, no windows of vulnerability exist that might allow malicious data to be written to persistent storage. AVFS is an on-access virus scanning system.

To reduce the amount of data scanned, AVFS stores persistent state. AVFS scans one page a time, but a virus may span multiple pages. After scanning one page, AVFS records state. When the next page is scanned, AVFS can resume scanning as if both pages were scanned together. After an entire file is scanned, AVFS marks the file clean. AVFS does not scan clean files until they are modified.

AVFS supports different forensic modes. One mode prevents a virus from ever reaching the disk. As soon as a process attempts to write a virus, AVFS returns an error to the process before the changes are made to the file. The second mode does not immediately return an error to the process. Before the first write to a file is committed, a backup of that file is made. If a virus is detected, then AVFS quarantines the virus (no other process can access a file while it is quarantined), allows the write to go through, records information about the event, and finally reverts to the original file. This leaves the system in a consistent state, and allows the administrator to investigate the event.

Different virus scanners may be adapted to work with AVFS. The virus scanner also includes a virus database of virus signatures. The virus scanner may be adapted to run in a kernel. By running the scanner in the kernel, data copies or context switches can be reduced. The virus scanner also allows the system administrator to decide what tradeoff should be made between memory usage and scanning speed. Since the number of viruses is continuously growing, these scalability improvements will become even more important in the future.

AVFS uses a page-based on-access virus scanner that scans in real time. AVFS has support for data-consistency using versioning and support for forensics by recording malicious activity. The scanning algorithm limits repetitive scanning using a state-oriented approach.

The virus scanner is separate from the file system module. A stackable file system allows for portability to different environments. The AVFS system is transparent in that no user intervention is needed and existing applications need not be modified to support virus protection.

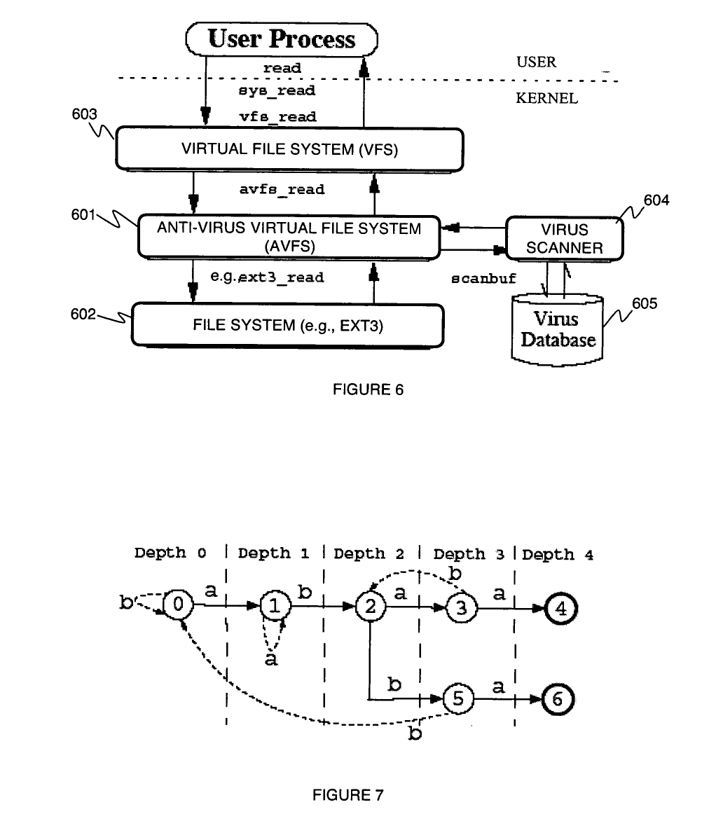

AVFS is a stackable file system that provides protection against viruses. FIG. 6 shows a view of an AVFS infrastructure. When the AVFS 601 is mounted over an existing file system 602, it forms a bridge between a Virtual File System (VFS) 603 and the underlying file system 602. The VFS calls various AVFS operations and AVFS calls the corresponding operations of the underlying file system. AVFS performs virus scanning and state updates during these operations. A virus-scanning engine 604 may be integrated into an operating system kernel. The virus-scanning engine 604 exports an application program interface (API) that is used by the AVFS 601 for scanning files and buffers of data. For example, a read from the VFS 603, vfs_read( ), translates into avfs_read( ) in the AVFS layer 601. The lower layer read method (ext3_read( )) is called and the data received is scanned in the AVFS layer 601.

The file system methods that the stacking infrastructure provides include read, write, open, and close. A page may be used as a basic data unit in the stackable file system. Reads and writes occur in pages and virus scanning is performed during individual page reads and writes. This level of granularity allows for viruses to be scanned before the data from a read( ) is delivered to the user and before the data from a write( ) propagates to the disk. The window of opportunity for any virus attack is significantly reduced. Further, consistency of the data is maintained in the files because data is scanned for viruses before it gets written to disk. In addition, with a state implementation, files may be scanned partially and incrementally. This state implementation also allows scanned files to be marked as clean so that they do not need to be re-scanned if they are not modified.

To better integrate the virus scanner 604 with the AVFS 601, the virus scanner 604 may be run in the kernel. A kernel-based virus scanner offers improved speed and security over user level scanners. Speed is improved by avoiding message passing and data copying between kernel and user space. Security is improved because the virus scanner cannot be trivially killed.

The virus scanner 604 may include a core scanner library as well as various command line programs. The virus definition database 605 contains virus patterns, for example, basic patterns that are a simple sequence of characters that identify a virus, and multi-part patterns that include more than one basic sub-pattern. To match a virus, all sub-patterns of a multipart pattern may match in order. The virus patterns may also contain wildcard characters. The combination of multi-part patterns and wildcard characters enables the virus scanner to detect polymorphic viruses. Polymorphic viruses are more difficult to detect than non-polymorphic viruses, because each instance of a polymorphic virus has a different footprint than other instances.

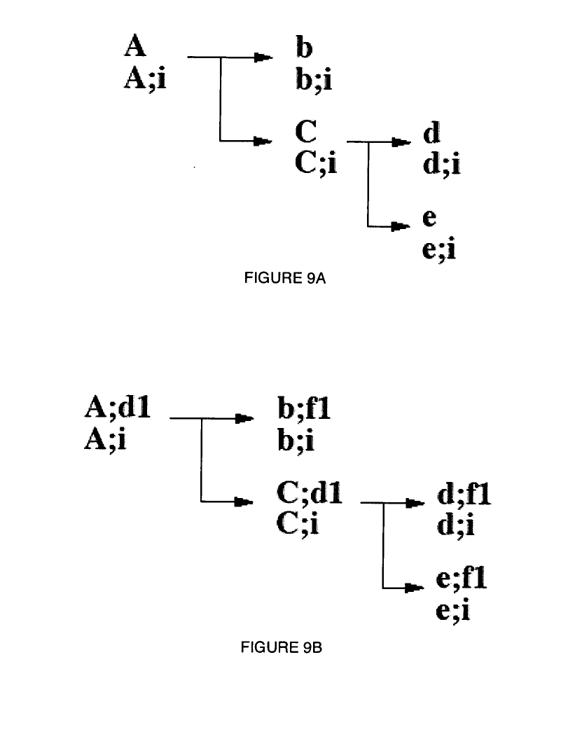

The virus scanner 604 may use a pattern-matching algorithm such as the Aho-Corasick method. The algorithm includes a pattern matching finite state machine and a text string used as the input to the automaton. To construct a pattern-matching automaton, the Aho-Corasick algorithm first builds a finite state machine for all of the patterns. FIG. 9 shows the automaton for two keywords “abaa” and “abba” over the alphabet {a,b}. State 0 denotes the starting state of the automaton, and the final states are shown with bold circles. The pattern “abaa” is added, creating states 0-4. The pattern “abba” is added, creating states 5-6. Two additional states were needed since both patterns share the same prefix “ab.” Transitions over the characters of the patterns are called success transitions.

Versioning File System

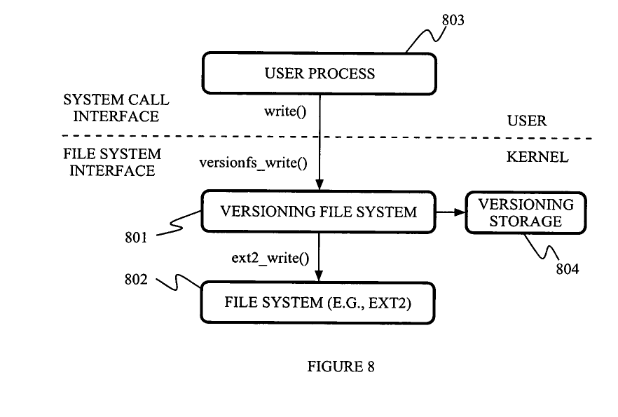

Referring to FIG. 8, a stackable file system may be implemented as a versioning file system (versionfs) 801 for displaying and comparing multiple versions of files. Versionfs 801 can transparently version whole files 802 upon user changes 803 to those files. Versionfs 801 can be run on clients, servers, or proxies. Versions can be taken based on a policy set by an administrator. Policies can limit, for example, the total number of versions saved, the maximum time they are saved, or the total disk space they consume. Version files can be compressed to save space; also versionfs 801 can take incremental “delta” versions that record only changes between individual disk blocks, pages of files, or lines of text. The versions are stored in a memory device 804, such as backup disk drive or physical memory. Versionfs 801 may be used in the context of secure systems: by taking versions, the system can recover from malicious attacks that corrupt or modify or even delete files.

Versionfs 801 operates at the highest possible layer inside the operating system. As shown in FIG. 2, versionfs operates at the stackable file system level 202. Versionfs 801 can operate on top of another file system 802 and transparently add versioning functionality without modifying existing file system implementations or native on-media structures. Versionfs 801 monitors relevant file system operations resulting from user activity 803, and creates backup files 804 when a user modifies a file. Version files are automatically hidden from the user and may be handled in a Unix-semantics compliant manner.

To be flexible for users and administrators, versionfs 801 supports various retention and storage policies. Retention policies determine how many versions to keep per file. Storage policies determine how versions are stored. The term “version set” includes a given file and all of its versions. A user-level dynamic library wrapper allows users to operate on a file or its version set without modifying existing applications such as ls, rm, or mv. A library of saved versions makes version recovery as simple as opening an old version with a text editor. This functionality removes the need to modify user applications and gives users flexibility to work with versions.

In versionfs 801, the head, or current, version is stored as a regular file, maintaining the access characteristics of the underlying file system. This design avoids a performance penalty for reading the current version. Each version is stored as a separate file. For example, the file foo's n-th version is named foo;Xn. X is substituted depending on the storage policy used for the version. X may be: “f” indicating a full copy, “c” indicating a compressed version, “s” indicating a sparse version, and “d” indicating a versioned directory. The user is restricted from directly creating or accessing files with names matching the above pattern.

A meta-data file (e.g., foo;i) is stored with each version set and contains the minimum and maximum version numbers as well as the storage method for each version. The meta-data file acts as a cache of the version set to improve performance. This file allows versionfs 801 to quickly identify versions and know what name to assign to a new version. On version creation, versionfs 801 also discards older versions according to defined retention policies.

Newly created versions are created using a copy-on-change policy. Copy-on-change differs from copy-on-write in that writes that do not modify data will not cause versions to be created. The dirty bit that the operating system or hardware provides is not sufficient, because it does not distinguish between data being overwritten with the same content or different one.

There are at least six types of operations that create a version of a file: a write to the file (e.g., either through write or mapping pages of memory (mmap)), unlink, removing a directory (rmdir), rename, truncate, and ownership or permission modifications (e.g., chown and chmod).

The write operations are intercepted by the stackable file system. Versionfs 801 creates a new version if the existing data and the new data differ. Between each open and close, only one version is created. This heuristic approximates one version per save. The unlink system call also creates a version. For some version storage policies (e.g., compression), unlink results in the file's data being copied. If the storage policy permits, then unlink is translated into a rename operation to improve performance. Translating unlink to a rename reduces the amount of I/O required for version creation.

The rmdir system call is converted into a rename, for example “rmdir foo” renames foo to foo;d1. A directory is renamed if the directory appears to be empty from the perspective of a user. To do this, a readdir operation is executed to ensure that all files are either versions or version set meta-data files. Deleted directories cannot be accessed unless a user recovers the directory. Directory recovery can be done using a user-level library that invokes a special-purpose ioctl.

The readdir operation returns a pointer to a dirent (format of directory entries) structure representing the next directory entry in the directory stream. The readdir operation returns NULL on reaching the end-of-file or if an error occurred. The data returned by readdir is overwritten by subsequent calls to readdir for the same directory stream.

FIG. 9A shows a tree before it is removed by rm-rf (remove recursively with force) and FIG. 9B shows the tree after it is removed by rm-rf. The rm command operates in a depth-first manner. First rm descends into A and calls unlink(b). To create a version for b, versionfs 801 instead renames b to b;f1. Next, rm descends into C, and d and e are versioned the same way b was. Next, rm calls rmdir on C. Versionfs 801 uses readdir to check that C does not contain any files visible to the user, and then renames it to C;d1. A is versioned by renaming it to A;d1. The rename system call needs to create a version of the source file and the destination file. The source file needs a version so that the user can recover it later using the source name. If the destination file exists, then it too is versioned so its contents are preserved. Whereas the history of changes is preserved to the data in a file, the file name history of a file may not be preserved because data versioning is more important to users than file-name versioning.

When renaming foo to bar, if both are regular files, the following scenarios are possible:
bar does not exist: In this case, a version of foo is created before renaming foo to bar. If both operations succeed, then the meta-data file bar;i is created.
bar exists: A version of bar is created. Subsequently, a version of foo is created. Then foo is renamed to bar.
bar does not exist but bar;i exists: This happens if bar has already been deleted and its versions and meta-data files were left behind. In this case, a version for foo is created, then foo is renamed to bar. For versioning bar, the storage policy that was recorded in bar;i is used.

The rename system call renames only the head version of a version set. Entire version sets can be renamed using the provided user-level library.

The truncate system call also creates a new version. However, when truncating a file foo to zero bytes, versionfs 801 renames foo to be the version. Versionfs 801 then recreates an empty file foo. This saves on I/O that would be needed for the copy.

File meta-data is modified when owner or permissions are changed, therefore chmod (change access permissions of a file) and chown (change the ownership of files and/or directories) also create versions. This may be useful for security applications. If the storage policy permits (e.g., sparse mode), then no data is copied.

Storage policies define the internal format for versions. The system administrator may set the default policy, which may be overridden by the user. Examples of storage policies include: full, compressed, and sparse mode.

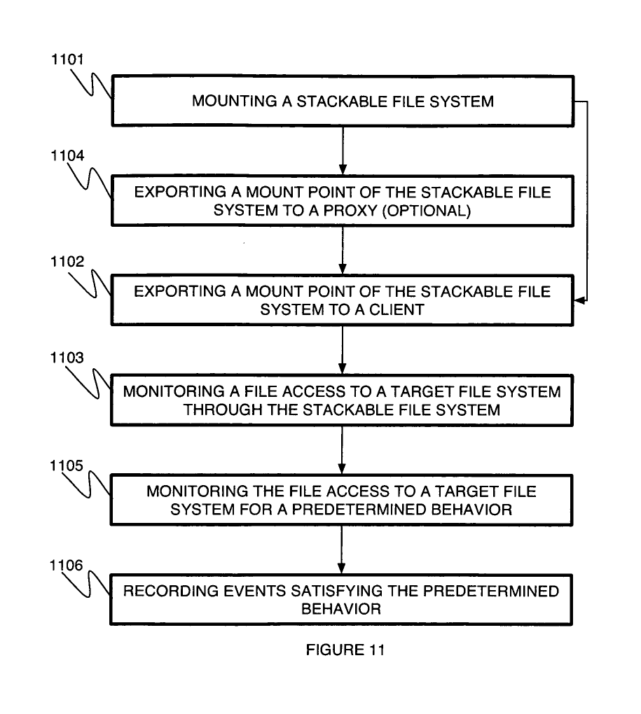

Full mode makes an entire copy of the file each time a version is created. As can be seen in FIG. 11, each version is stored as a separate file of the form foo;fN, where N is the version number. The current, or head, version is foo. The oldest version in the diagram is foo;f8. Before version 8 is created, its contents are located in foo. When the page A2 overwrites the page A1, versionfs 801 copies the entire head version to the version, foo;f8. After the version is created, A2 is written to foo, then B1, C2, and D2 are written without any further version creation. This demonstrates that in full mode, once the version is created, there is no additional overhead for read or write. The creation of version 9 is similar to the creation of version 8. The first write overwrites the contents of page A2 with the same contents. Versionfs 801 does not create a version as the two pages are the same. When page B2 overwrites page B1, the contents of foo are copied to foo;f9. Further writes directly modify foo. Pages C2, D3, and E1 are directly written to the head version. Version 10 is created in the same way. Writing A2 and B2 do not create a new version. Writing C3 over C2 will create the version foo;f10 and the head file is copied into foo;f10. Finally, the file is truncated. Because a version has already been created in the same session, a new version is not created.

Compress mode is similar to full mode, except that the copies of the file are compressed. If the original file size is less than one block, then versionfs 801 may not use compression. Compress mode reduces space utilization and I/O wait time, but may need more system time. Versions can also be converted to compress mode offline using a cleaner.

When holes are created in files (e.g., through lseek and write), file systems like Ext2, FFS, and UFS do not allocate blocks. Files with holes are called sparse files. Sparse mode versioning stores only block deltas between two versions. Blocks that change between versions are saved in the version file. It uses sparse files on the underlying file system to save space.

Compared to full mode, sparse mode versions reduce the amount of space used by versions and the I/O time. The semantics of sparse files are that when a sparse section is read, a zero-filled page is returned. There may be no way to differentiate this type of page with a page that is genuinely filled with zeros. To identify which pages are holes in the sparse version file, versionfs 801 stores sparse version meta-data information at the end of the version file. The meta-data contains the original size of the file and a bitmap that records which pages are valid in this file. Versionfs 801 does not pre-allocate intermediate data pages, but does leave logical holes. These holes allow versionfs 801 to backup changed pages on future writes without costly data-shifting operations.

Two properties of the sparse format are: a normal file can be converted into a sparse version by renaming it and then appending a sparse header; and tail versions may be discarded because reconstruction only uses more recent versions.

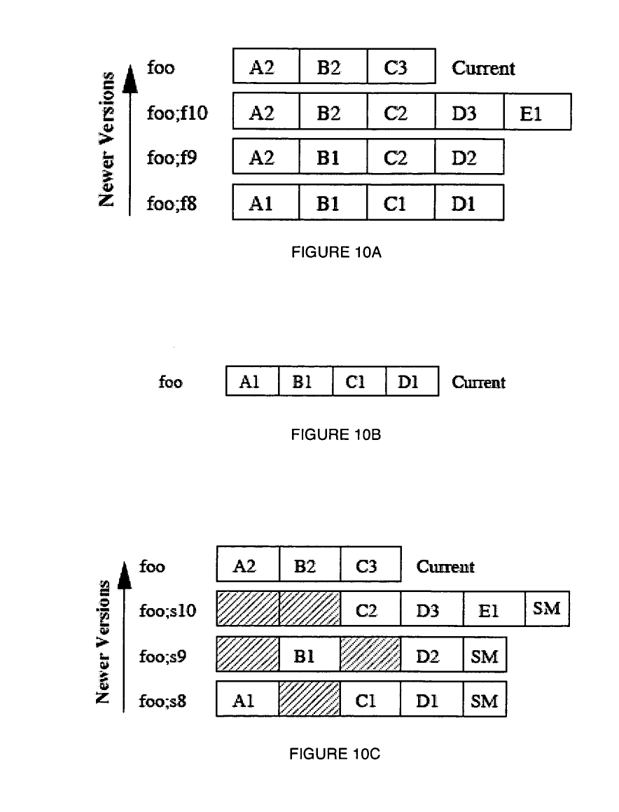

To reconstruct version N of a sparse file foo, versionfs 801 opens foo;sN. Versionfs 801 reconstructs the file one page at a time. If a page is missing from foo;sN, then the next version is opened and an attempt is made to retrieve the page from that version. This process is repeated until the page is found. This procedure always terminates, because the head version is always complete. FIG. 10B shows the contents of foo when no versions exist. A meta-data file, foo;i, which contains the next version number, also exists. FIG. 10C shows the version set after applying the same sequence of operations as in FIG. 10A, but in sparse mode.

Versionfs 801 creates foo;s8 when write( ) tries to overwrite page A1 with A2. Versionfs 801 allocates a new disk block for foo;s8, writes A1 to the new block, updates the sparse bitmap and overwrites A1 with A2 in foo. This strategy helps preserve sequential read performance for multi-block files. The other data blocks are not copied to foo;s8 yet and foo;s8 remains open. Next, write( ) overwrites page B1 with the same data. Versionfs 801 does not write the block to the sparse file because data has not changed. Next, C2 overwrites C1 and versionfs 801 first writes C1 to the sparse file and then writes C2 to the head version. Versionfs 801 also updates the sparse meta-data bitmap. Page D is written in the same way as page C. The creation of version 9 is similar to version 8. The last version in this sequence is version 10. The pages A2, B2, and C3 are written to the head version. Only C3 differs from the previous contents, so versionfs 801 writes only C2 to the version file, foo;s10. The file is truncated to 12 KB (three 4 KB pages), so D3 and E1 are copied into foo;s10. The resulting version set is shown in FIG. 10C.

Various version retention policies may be developed. The retention policies, which may include Elephantfs's retention policies, determine how many versions need to be retained for a file. Examples of retention policies include number, space, and time.

For “number” the user can set the maximum and minimum number of versions in a version set. This policy is attractive because some history is always kept.

In “time” the user can set the maximum and minimum amount of time to retain versions. This allows the user to ensure that a history exists for a certain period of time.

For the “space” retention policy, the user can set the maximum and minimum amount of space that a version set can consume, for example, some number of megabytes. This policy allows a deep history tree for small files, but does not allow one large file to use an undesirably large amount of space (e.g., more than defined as the maximum).

A version is never discarded if discarding it violates a policy's minimum. The minimum values take precedence over the maximum values. If a version set does not violate any policy's minimum and the version set exceeds any one policy's maximum, then versions are discarded beginning from the tail of the version set.

Providing a minimum and maximum version is useful when a combination of two policies is used. For example, a user can specify that the number of versions to be kept should be 10-100 and 2-5 days of versions should be kept. This policy ensures that both the 10 most recent versions and at least two days of history is kept. Minimum values ensure that versions are not prematurely deleted, and maximums specify when versions should be removed.

Each user and the administrator can set a separate policy for each file size, file name, file extension, process name, and time of day. File size policies are useful because they allow the user to ensure that large files do not use too much disk space. File name policies are a convenient method of explicitly excluding or including particular files from versioning. File extension policies are useful because file names are highly correlated with the actual file type. This type of policy could be used to exclude large multimedia files or regenerable files such as .o files. This can also be used to prevent applications from creating excessive versions of unwanted files. For example, excluding “^{˜}” from versioning will prevent emacs from creating multiple versions of “^{˜}” files.

Process name policies can be used to exclude or include particular programs. A user may want any file created by a text editor to be versioned, but to exclude files generated by their Web browser. Time-of-day policies are useful for administrators because they can be used to keep track of changes that happen outside of business hours or other possibly suspicious times. For all policies, the system administrator can provide defaults. Users can customize these policies. The administrator can set the minimum and maximum values for each policy. This is useful to ensure that users do not abuse the system. In case of conflicts, administrator defined values override user-defined values. In case of conflicts between two retention policies specified by a user, the most restrictive policy takes precedence.

By default, users are allowed to read and manipulate their own versions, though the system administrator can turn off read or read-write access to previous versions. Turning off read access is useful because system administrators can have a log of user activity without having the user know what is in the log. Turning off read-write access is useful because users cannot modify old versions either intentionally or accidentally.

Versionfs 801 exposes a set of ioctls (I/O control codes) to user space programs, and relies on a library, libversionfs to convert standard system call wrappers into versionfs ioctls. The libversionfs library can be used as an LD_PRELOAD library that intercepts each library system call wrapper and directory functions (e.g., open, rename, or readdir). After intercepting the library call, libversionfs determines if the user is accessing an old version or the current version or a file on a file system 1002 other than versionfs 801. If a previous version is being accessed, then libversionfs invokes the desired function in terms of versionfs ioctls; otherwise the standard library wrapper is used. The LD_PRELOAD wrapper greatly simplifies the kernel code, as versions are not directly accessible through standard VFS methods.

Versionfs 801 provides the following ioctls: version set stat, recover a version, open a raw version file, and also several manipulation operations (e.g., rename and chown). Each ioctl takes the file descriptor of a parent directory within versionfs 801. When a file name is used, it is a relative path starting from that file descriptor.

Version-set stat (vs_stat) returns the minimum and maximum versions in a version set and the storage policy for each version. This ioctl also returns the same information as stat(2) for each version.

The version recovery ioctl takes a file name F, a version number N, and a destination file descriptor D as arguments. It writes the contents of F's N-th version to the file descriptor D. Providing a file descriptor gives application programmers flexibility. Using an appropriate descriptor they can recover a version, append the version to an existing file, or stream the version over the network. A previous version of the file can even be recovered to the head version. In this case, version creation takes place as normal.

The open-raw ioctl is used by libversionfs to open a version file. To preserve the version history integrity, version files can be opened for reading only. The libversionfs library recovers the version to a temporary file, re-opens the temporary file read-only, unlinks the temporary file, and returns the read-only file descriptor to the caller. After this operation, the caller has a file descriptor that can be used to read the contents of a version.

Opening a raw version returns a file descriptor to an underlying version file. Users are not allowed to modify raw versions. This ioctl is used to implement readdir and for our version cleaner and converter. The application must first run the version-set stat to determine what the version number and storage policy of the file are. Without knowing the corresponding storage policy, the application cannot interpret the version file correctly. Through the normal VFS methods, version files are hidden from user space. Therefore, when an application calls readdir, it will not see deleted versions. When the application calls readdir, libversionfs runs readdir on the current version of the raw directory so that deleted versions are returned to user space. The contents of the underlying directory are then interpreted by libversionfs to present a consistent view to user space. Deleted directories cannot be opened through standard VFS calls, therefore we use the raw open ioctl to access them as well.

Also provided are ioctls that rename, unlink, rmdir, chown, and chmod an entire version set. For example, the version-set chown operation modifies the owner of each version in the version set. To ensure atomicity, versionfs locks the directory while performing version-set operations. The standard library wrappers simply invoke these manipulation ioctls. The system administrator can disable these ioctls so that previous versions are not modified.

All versions of files are exposed by libversionfs. For example, version 8 of foo is presented as foo;8 regardless of the underlying storage policy. Users can read old versions simply by opening them. When a manipulation operation is performed on foo, then all files in foo's version set are manipulated.

An example session using libversionfs is as follows. Typically users see only the head version, foo.
$ echo-n Hello >foo
$ echo-n “, world”>>foo
$ echo “!”>>foo
$ ls
foo
$ cat foo
Hello world!

Users may set an LD_PRELOAD to see all versions.
$ LD_PRELOAD=libversionfs.so
$ export LD_PRELOAD

After using libversionfs as an LD_PRELOAD, the user sees all versions of foo in directory listings and can then access them. Regardless of the underlying storage format, libversionfs presents a consistent interface. The second version of foo is named foo;2. There are no modifications required to standard applications.
$ Is
foo foo;1 foo;2
   If users want to examine a version, all they need to do is open it. Any dynamically linked program that uses the library wrappers to system calls can be used to view older versions. For example, diff can be used to examine the differences between a file and an older version.
$ cat ‘foo;1’
Hello
$ cat ‘foo;2’
Hello, world
$ diff foo ‘foo;1’
1c1
<Hello, world!
- - -
>Hello

libversionfs can also be used to modify an entire version set. For example, the standard mv command can be used to rename every version in the version set.
$ mv foo bar
$ ls
bar bar;1 bar;2

A version cleaner and converter may be implemented using the version-set stat and open-raw ioctls. As new versions are created, versionfs 801 prunes versions according to the retention policy. Versionfs 801 does not evaluate the retention policies until a new version is created. To account for this, the cleaner uses the same retention policies to determine which versions should be pruned. Additionally, the cleaner can convert versions to more compact formats (e.g., compressed versions).

The cleaner is also responsible for pruning directory trees. Directories in the kernel may not be pruned because recursive operations are expensive to run in the kernel. Additionally, if directory trees were pruned in the kernel, then users would be surprised when seemingly simple operations take a significantly longer time than expected. This could happen, for example, if a user writes to a file that used to be a directory. If the user's new version needed to discard the entire directory, then the user's simple operation would take an inexplicably long period of time.

In the event of a crash, the meta-data file can be regenerated entirely from the entries provided by readdir. The meta-data file can be recovered because we can get the storage method and the version number from the version file names. Versionfs 801, however, depends on the lower level file system to ensure consistency of files and file names. A high-level file system checker similar to fsck may be used to reconstruct damaged or corrupt version meta-data files.

Other applications of the stackable file system are possible, including an encryption application. By wrapping other file systems, stackable file systems can monitor file system activity that comes from users before that activity is passed on to the actual file system that the stackable file system is wrapping. Referring to FIG. 11, stackable file system implementations include mounting a stackable file system on top of a target file system 1101, wherein a stackable file system is loaded in a kernel below a system call level and above a network layer, exporting a mount point of the stackable file system to a client 1102, and monitoring a file access to the target file system, through the stackable file system, by the client 1103.

The stackable file system is mounted on one or a server comprising the target file system. The export of the target file system may be to a proxy 1104, wherein the proxy exports the mount point of the stackable file system to the client 1102. The stackable file system monitors file access to the target file system for predetermined behavior 1105, for example, performing traces, or anti-virus detection. The predetermined behavior may be, for example, a certain number of deletes performed in a given time period, or access to a certain file. Information about events that satisfy the predetermined behavior is stored for later analysis 1106.

Encryption

Typically, only superusers can mount new file systems to a directory. Since each user may want their own encrypted directory, with their own keys etc., each user would need a separate mount point. Many mounts are costly and inefficient in operating systems. A stackable encryption file system (SEFS) allows a file system to be mounted as an empty directory. Users can “attach” a directory to the SEFS. This attachment is done via a set of calls, e.g., ioctl(2), that add the user's private directory into the encrypted name-space. As part of the attachment process, the SEFS performs checks to ensure the authenticity and security of the user performing the mount. With attach-mode mounts, users can safely “mount” and “unmount” any number of directories without needing superuser privileges or more than one kernel mount structure. Data stored using the SEFS remains confidential, by using strong encryption to store data. The kernel notifies the SEFS upon the death of a process and evict cleartext pages from the cache. The SEFS makes encryption transparent to the application: any existing application can make use of strong cryptography with no modifications. The SEFS is cipher agnostic, so it is not tied to any one cipher.

The SEFS makes the assumption that the underlying storage media can be read and tampered with, so to ensure data confidentiality, it needs to be encrypted. Before the encrypted data is used, the owner must provide the key to the SEFS, for example, by entering a passphrase. Once the key is sent to kernel space, the SEFS stores it in core memory. The SEFS will use the encryption key on behalf of readers and writers, without revealing it to them. When cryptographic algorithms are used for authentication, authentication information is distinct from the encryption key. After the initial authentication takes place, the result is bound to a specified user, group, session, or process.

The SEFS uses a long-lived key to encrypt all data and file names written to disk. If we used a short-lived key, then whenever the key changed, all data would have to be re-encrypted. To avoid this performance penalty, we use long-lived keys. The SEFS uses the underlying file system to store ciphertext data, but all other data related to the encryption key is stored in pinned core memory that cannot be swapped to disk.

The SEFS is cipher agnostic. It uses cipher modules that are treated as simple data transformations. The SEFS uses a cipher that encrypts an arbitrary length buffer into a buffer of the same size. The ciphers performs this encryption in Cipher Feedback Mode (CFB). CFB mode maintains equal size encrypted files. Changing the size of files may complicate stackable file systems and decreases performance. Selecting an appropriate cipher allows the user to select where they want to lie on the security-performance-convenience continuum. If the user is more concerned about performance, then a faster but less secure cipher may be chosen (e.g., one with a shorter key length).

Each encryption key is associated with an attach. Attachments allow owners to have personal encrypted directories. An attach is similar to a separate instance of a stackable file system. Each attach has a corresponding directory entry within the SEFS mount 202 point and stacks on a different lower-level directory 201 as shown in FIG. 2.

An attach can be thought of as a lightweight user-mode mount. Unlike a regular mount, the SEFS attach cannot hide any data because SEFS does not allow any files or directories to be created in the root of the SEFS. The SEFS presents an unencrypted view of the existing data in the system, without modifying metadata.

Using an attach permits the use of a specific type of stackable enhancement for many lower directories without running into hard limits or degrading system performance for other operations. The SEFS may use, for example, the directory cache (dcache) in Linux to store attaches, because the dcache organizes many entries efficiently.

Further, the SEFS has a completely separate name space for each set of encrypted files. Each attach has private data that is relevant only to that specific attachment. The per-attach data is made up of an encryption key, authorizations (e.g., access control entries), and active sessions. These data structures separate encryption, authorization, and active sessions. These data structures model flexible and diverse policies including ad-hoc groups.

The encryption key information is specific to the cipher for this attach. This data includes the encryption key and any information, such as initialization vectors, needed to perform encryption. The SEFS passes this data to each encryption or decryption operation, but has no knowledge about the contents of this data. The cipher is wholly responsible for its maintenance and interpretation. This data is opaque to the SEFS so that a multitude of ciphers can be used without any modifications to the SEFS.

For authorizations, each attach has one or more authorizations. An authorization gives an entity access to the SEFS after the entity meets a certain authentication criteria. An entity may be a process, session, user, or group. The authentication criteria includes a method (e.g., password) and data that is specific to this method (e.g., a salted hash of the password).

Each attach also has one or more active sessions. An active session includes the description of an entity and the permissions granted to that entity. Active sessions of the SEFS are not necessarily the same as UNIX sessions (e.g., an active session can be bound to a user or process). Once an entity has authenticated according to the rules in an authorization, an active session is created. One authorization can map to multiple active sessions (e.g., a user authenticates in two sessions using a single authorization entry). Each active session corresponds to an authorization that exists or existed in the past. If an authorization is removed, the active sessions are allowed to remain.

For flexibility, the SEFS uses fine-grained permissions. Each authorization and active session contains a bitmask of permissions. The permissions include read, write, and execute bits in addition to operations, including: “Detach” that allows removal of the attachment from the SEFS; “Add an Authorization” allows users to delegate a subset of their permissions to new authorizations; “List Authorizations” allows users to verify and examine which entities (e.g., users, sessions, processes, and groups) are authorized to use this attach; “Delete an Authorization” allows users to remove an authorization from an attach; “Revoke an Active Session” allows users to prevent a currently-authenticated user from accessing the SEFS; “List Active Sessions” allows users to verify and examine which users have authenticated to an attach; and “Bypass VFS Permissions” allows users to take on the identity of the file's owner for files within the attach. This permission is required to implement ad-hoc groups, which allow the convenient sharing of encrypted data.

By default, any user is allowed to create an attachment with full permissions, except bypass VFS permissions. The system administrator can change the default policy by adding authorizations to the SEFS mount point. Each authorization allows a single entity to attach or authenticate to an attach. The main SEFS mount point has no active sessions, only authorizations. The mount point cannot require authentication, because authentication takes place through an ioctl. If the user has not already been granted permission, then the ioctl will not be permitted. Once the attach or authentication takes place, the entity receives a subset of permissions in the authorization. Authorizations for the SEFS mount point may use two additional permissions: “attach” allows a user to create an attach; and “authentication” allows a user to authenticate to an attach.

The system administrator can also limit the maximum numbers of attaches and the maximum and minimum key timeouts both on a global and on a per user basis.

Methods for generating attach names include: user selection; generation of a name based on the entity doing the attaching, preventing name space collisions between users; and random generation of unique attach names.

The SEFS may support native UNIX groups. The SEFS may support ad-hoc groups by adding authorizations for several individual users or other entities. The bypass-VFS-permissions option allows the owner of the attach to delegate permissions, assuming root has given it to the owner. When this is enabled, the SEFS performs permission checks independently of the lower-level file system.

Keys, authorizations, and active sessions all may have a timeout associated with them. When an object times out, the SEFS executes a user-space program optionally specified at attach time. For example, the user may specify an application that ties into a graphical desktop environment to prompt for the user's passphrase. The SEFS may cause further file system operations to fail with “permission denied.” The SEFS may cause the opening of a file to fail, but allow already opened files to continue to function. Further, files that are already open may be allowed to continue to function, but when a user attempts to open a new file, the process is put to sleep until the operation can succeed, e.g., the user re-authenticates. Further still, all operations may cause the process to be put to sleep until the operation can succeed: open, read, write, etc. block until re-authentication.

An authorization timeout prevents new users from authenticating with that authorization, but active sessions may continue to use the attach.

An SEFS kernel thread wakes up sleeping processes after a user-specified duration. The function that caused the process to sleep returns an error.

Active sessions can be revoked. A timeout is a special case of a revocation because it is a scheduled revocation, so an active session revocation has the same behavior as an active session timeout with one key difference. If an active session times out, then it may be indefinitely extended by re-authenticating even if the corresponding authorization was removed. When an active session is revoked, it may not be re-enabled.

Cleartext pages may be evicted from the page cache, periodically and on detach. Unused dentries and inodes are also evicted from the dcache and icache, respectively. For added security at the expense of performance, SEFS may purge cleartext data from caches more often.

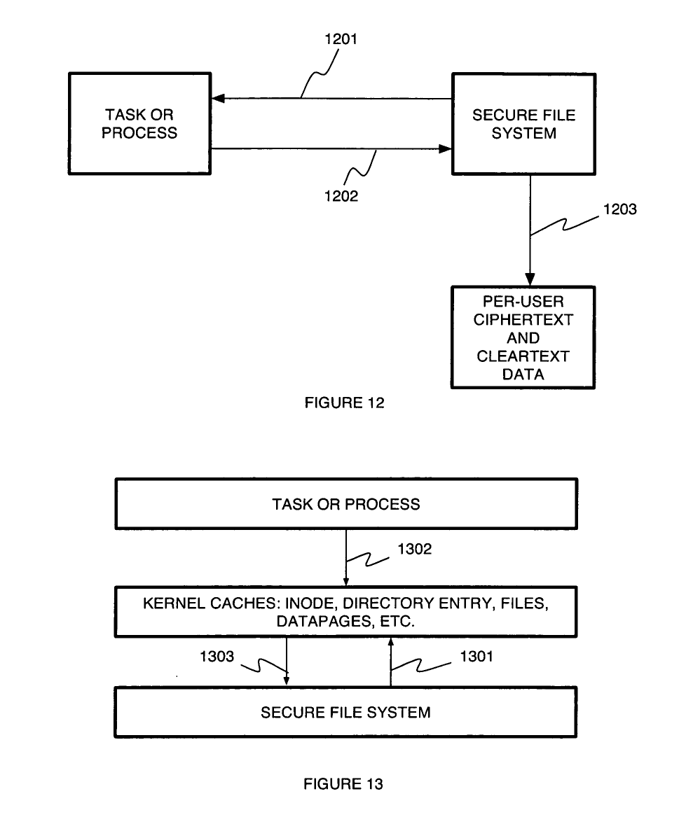

To ensure the security of the stackable encrypting file system, kernel features can be added. For example, a process/task structure on-exit callback method allows encryption keys to be associated with specific users, processes, or session leaders. Referring to FIG. 12, a callback function to be called when a task terminates is installed 1201. The callback function is called before the task terminates 1202. The file system purges predetermined data from memory 1203, for example, data denoted as confidential. When the processes or tasks terminate, it can be ensured that the all associated security information is purged along with the process, for example, cipher keys, authentication data, cached buffers, etc. Another example of a kernel feature performs a cache validity check for encryption file systems to invalidate cached objects that used expired authentication keys or cipher keys that have changed. Referring to FIG. 13, a callback function to be called is installed when cached objects, such as inodes, directory entries, files, data pages, etc., are found in the cache, but before they are returned to user processes 1301. A task runs in the kernel and invokes a cache to retrieve an object 1302. A cache code invokes the previously installed callback 1303, thus calling the actual file system, which can certify the validity of the objects before they are returned. Further, invalid objects are purged and recreated after access controls are applied. Page caches often reside right in front of file systems, for efficiency reasons. However, cached objects can be used without consulting the file system. Some cached objects may represent ciphertext data, while others represent cleartext data; having those objects in the page cache presents security vulnerabilities and may allow attacks on the page cache itself. Therefore, before a cached object that belongs to a cryptographic file system is used, the file system is consulted to validate the object. Accordingly, the file system invalidates cached objects that used expired authentication keys or cipher keys that have changed.

The stackable encryption system can implement authentication and encryption keys provided by a user. The SEFS allows a delayed or subsidiary authentication of applications. These features may be configurable per process.

To ensure data confidentiality, the SEFS may use strong cryptography algorithms (e.g., Blowfish or AES in CFB mode). File data and file names are handled in two different ways. Data is encrypted one page at a time, using an initialization vector (IV) specified along with the encryption key XORed with the inode number and page number. File names are encrypted with the IV XORed with the inode number of the directory. While the output may include characters that are not valid UNIX pathnames (e.g., /and NULL), the result may be base-64 encoded before being passed to the lower-level file system. This reduces the maximum path length by 25%. A checksum is stored at the beginning of the encrypted file name, wherein if a file name is not encrypted with the correct key, then this checksum will prevent it from appearing in the SEFS, and since CFB mode is used, if two files have a common prefix, then they will have a common encrypted prefix. Since it is unlikely that these two files will have the same checksum, prefixing their names with the checksum will prevent them from having the same prefix in the ciphertext. Further, the directory entries “.” and “..” are not encrypted to preserve the directory structure on the lower-level file system.

Having described embodiments for a system and method for a stackable file system, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. An operating system kernel comprising a protocol stack comprising:
a network layer for receiving a message from a data network;
a stackable file system layer coupled to the network layer for inspecting the message, wherein the stackable file system layer is coupled to a storage device, the stackable file system determining and storing file system level information determined from the message; and
a wrapped file system comprising a file targeted by the message coupled to the stackable file system layer for receiving the message inspected by the stackable file system.

2. The protocol stack of claim 1, wherein the stackable file system layer comprises a filter, wherein the message is compared to the filter, the filter being one of a virus signature, and an expression specifying an object and an operation.

3. The protocol stack of claim 1, wherein the stackable file system layer comprises a filter, wherein the message is compared to the filter, the filter specifying file system operations triggering a version save to the storage device.

4. The protocol stack of claim 1, further comprising a virus scanning engine coupled between the stackable file system and the storage device, wherein the storage device includes a virus database of virus signatures accessed by the virus scanning engine.

5. The protocol stack of claim 4, wherein the message is scanned by the virus-scanning engine before data from a read is delivered to a user and before data from a write propagates to a data storage device.

6. The protocol stack of claim 1, wherein the stackable file system layer stores a version of the file targeted by the message upon determining a change in the file.

7. The protocol stack of claim 2, wherein the filter performs an operation trace, wherein the filter comprises:
an input filter for determining an operation to trace;
an assembly driver for converting the operation into a stream;
an output filter for performing a stream transformation; and
an output driver for writing the stream out from the kernel to the storage device.

8. A stackable file system method comprising:
mounting a stackable file system on top of a target file system, wherein a stackable file system is loaded in a kernel below a system call level and above a network layer;
exporting a mount point of the stackable file system to a client;
monitoring a message targeting a file in the target file system, through the stackable file system; and
storing information about the message upon determining that the message satisfies a filter.

9. The method of claim 8, wherein the stackable file system is mounted on a server comprising the target file system.

10. The method of claim 9, further comprising exporting the target file system to a proxy, wherein the proxy performs the exporting of the mount point of the stackable file system to a client.

11. The method of claim 8, wherein monitoring further comprises:
determining an operation in the message to trace;
converting the operation in a stream;
transformating the stream; and
writing the stream to a trace storage device.

12. The method of claim 11, wherein the transformation is one of a compression, an encryption, and a checksum.

13. The method of claim 8, wherein monitoring comprises:
comparing the message to the filter on-access, wherein the filter is a virus signature is a virus database; and
determining the message to include a virus upon determining a match; and
storing a version of the message including the virus.

14. The method of claim 13, wherein the on-access comparison is performed when a file is created, when the file is read for a first time, and when the file in modified.

15. The method of claim 8, wherein monitoring comprises:
determining the message to include an operation to change the target file system upon comparing the message to the filter, wherein the filter is a policy set; and
storing a version of the target file system upon making the change.

16. The method of claim 15, wherein the version is stored as a sparse file.

17. The method of claim 15, wherein the version is stored as a full or compressed file.

18. An operating system kernel having a protocol stack comprising:
a network layer for receiving a message from a data communications network;
a stackable file system layer coupled to the network layer adapted to encrypt or decrypt the message received the network layer, wherein the stackable file system layer is kernel mount providing an attachment point for one or more directories, each directory being added to an encrypted name-space of the stackable file system layer.

19. The operating system kernel of claim 18, wherein an owner of each directory provides a directory key to the stackable file system layer, wherein the stackable file system layer stores the key in a kernel space of the operating system kernel.

20. The operating system kernel of claim 19, wherein the owner is authenticated and bound to at least one of a user, a group, a session, a process, a process group, a time-of-day range, a client host MAC address or IP address.

21. The operating system kernel of claim 18, comprising a long-lived key used by the stackable file system layer to encrypt or decrypt data and meta-data, wherein the stackable file system layer uses the network layer to store ciphertext data, and a pinned core memory to store an encryption key.

22. The operating system kernel of claim 18, further comprising a cipher module for performing data encryption or data decryption.

23. The operating system kernel of claim 18, comprising variable length buffers for receiving encrypted data, the variable length buffer having a length equal to the length of the encrypted data.

24. The operating system kernel of claim 18, wherein encryption is performed in a cipher feedback mode.

25. The operating system kernel of claim 18, wherein the stackable file system layer associates each attached directory with an individual encryption key.

26. The operating system kernel of claim 18, the stackable file system layer maintains a separate name space for each set of encrypted files, wherein the separate name-space comprises an encryption key, one or more authorizations, and one or more active sessions.

27. The operating system kernel of claim 26, wherein the encryption key is specific to a cipher for the attached directory.

28. The operating system kernel of claim 26, each authorization and active session comprises a bitmask of permissions.

29. The operating system kernel of claim 18, wherein the stackable file system layer associates timeouts with at least one of a key, an authorization, and an active session.
